(19) United States
(12) Patent Application Publication
(10) Pub. No.: US 2003/0116122 A1
(43) Pub. Date: Jun. 26, 2003

(54) Fuel injection pump for internal combustion engines, especially diesel engines

(76) Inventors: Rainer Haeberer, Bretten (DE); Frieder Buerkle, Stuttgart (DE); Helmut Clauss, Eberdingen (DE); Markus Rueckle, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/181,624

(22) PCT Filed: Nov. 16, 2001
(86) PCT No.: PCT/DE01/04320

(30) Foreign Application Priority Data
Nov. 30, 2000 (DE) 100 59 425.5

(51) Int. Cl. F02B 17/00

(52) U.S. Cl. 123/295

(57) ABSTRACT

A fuel injection pump for internal combustion engines, in particular Diesel engines, having a pressure limiting valve which has a valve holder (10), a high-pressure connection (inlet bore 18), a return connection (outlet bore 22, 22a, 22b, 44, 45), a valve seat (20) oriented toward the inlet bore, an axially displaceable valve piston (15, 43), and a valve spring (25) urging the valve piston in the direction of the valve seat. The special feature is primarily that the pressure limiting valve is integrated directly with the fuel injection pump and is sealed off on the high-pressure side and low-pressure side (at 37 and 38, 39, respectively) from the pump body.

As a result of these provisions, it is successfully possible to reduce the installation space that must be furnished for a fuel injection pump of the type in question, and to dispense with separate return lines.

### PRIOR ART

The invention relates to a fuel injection pump as generically defined by the preamble to claim 1.

A fuel injection pump of the type defined above has been disclosed by German Patent Disclosure DE 198 22 671 A1. The pressure limiting valve described there is intended (for instance, rail, function block, etc.) solely for mounting outside the fuel injection pump (high-pressure pump), for instance. The known design requires a correspondingly large amount of space, and a line system for the return line for whatever fuel is not needed is required.

The object of the invention is to reduce the installation space that must be furnished for a fuel injection pump of this type.

### ADVANTAGES OF THE INVENTION

According to the invention, the object is attained, in a fuel injection pump of the type defined at the outset, by the characteristics of the body of claim 1.

The essential advantages of the invention over the aforementioned prior art, that is, a fuel injection pump with an externally mounted pressure limiting valve, are considered to be that less space for the fuel injection system is required, since the pump and the pressure limiting valve now form a functional unit. This in turn has the further advantage that the return from the pressure limiting valve can be introduced directly into the high-pressure pump, making a separate return line unnecessary.

Advantageous refinements of the invention and practical embodiment options for its fundamental concept can be learned from claims 2-26.

### DRAWING

The invention is illustrated in terms of exemplary embodiments in the drawing, which are described in detail below. Shown are:

FIG. 1—in vertical longitudinal section—one embodiment of a—single-stage—pressure limiting valve;

FIG. 2—in the form of a graph—the characteristic of the system pressure (P), plotted over the valve throughput (Q), for the pressure limiting valve of FIG. 1;

FIG. 3—a different embodiment of a pressure limiting valve—in this case with two stages—in a view corresponding to FIG. 1;

FIG. 4—the characteristic pressure curve of the pressure limiting valve of FIG. 3, in a graph corresponding to FIG. 2;

FIG. 5—a further embodiment of a—two-stage—pressure limiting valve, in a view corresponding to FIGS. 1 and 3;

FIG. 6—the characteristic pressure curve of the pressure limiting valve of FIG. 5, in a graph corresponding to FIGS. 2 and 4;

FIG. 7—a further embodiment of a—single-stage—pressure limiting valve, in a sectional view corresponding to FIGS. 1, 3 and 5; and

FIG. 8—the characteristic pressure curve of the pressure limiting valve of FIG. 7, in a graph corresponding to FIGS. 2, 4 and 6.

### DESCRIPTION OF THE EXEMPLARY EMBODIMENTS

In FIGS. 1, 3 and 7, 10 designates an essentially cylindrical valve holder with a stepped bore 11, 12 which is embodied as a blind bore. In the (lower) part 11 of larger diameter of the stepped bore 11, 12, a cylindrical valve insert 13 is disposed fixedly and sealingly, being press-fitted into place, for example, and it has a guide bore 14 that is coaxial with the stepped bore 11, 12. A valve piston defined overall by reference numeral 15 is disposed axially displaceably in the guide bore 14 and comprises an (upper) cylindrical part 16 and a (lower) conical part 17. Located on the lower end of the valve insert 13 is a stepped inlet bore 18 (high-pressure connection), which has a sharply narrowed (throttle) cross section in an upper portion 19 that changes over into the guide bore 14. The portion 19 forms a valve seat—at 20—which cooperates with the tip of the conical valve piston part 17. A (lower) part, located in the region of the valve seat 20, of the piston guide bore 14 forms—because of the conical portion 17 of the valve piston 15—a valve chamber 21, from which a first outlet bore 22 penetrating the valve insert 13 in the transverse direction originates, which leads directly into the camshaft chamber (not shown) of the applicable fuel injection pump (high-pressure pump).

The rear end, remote from the valve seat 20, of the valve piston 15 is adjoined by a boltlike stop part 23, which protrudes here into the (upper) portion 12 of smaller diameter of the stepped bore 11, 12, which portion forms a corresponding cylindrical chamber. Also disposed in this cylindrical chamber 12 is a valve spring 25, which surrounds the boltlike stop part 23 and is braced at the rear on the bottom, marked 24, of the cylindrical chamber 12. The bottom 24 at the same time forms a counterpart stop for the boltlike stop part 23. On its other end, which has narrowed cross section, the valve spring 25 urges the valve piston 15 in the direction of the arrow 28, via a disk 26 that rests on a shoulder 27 of the valve piston 15, and as a result presses the valve piston into its closing position, visible in FIGS. 1, 3 and 7, or in other words presses it against the valve seat 20.

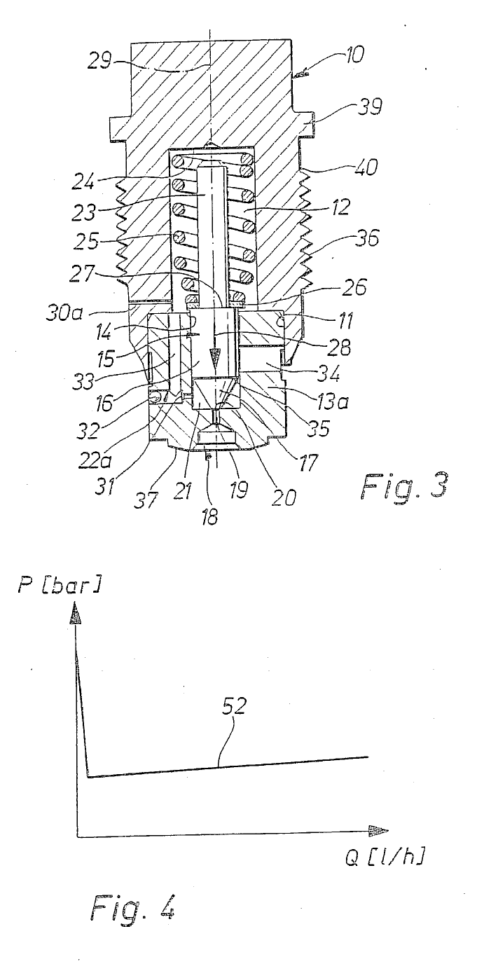

From the cylindrical chamber 12—in the transverse direction to the common longitudinal axis 29 of the valve holder 10, bore 11, 12 and valve piston 15—a second outlet bore 30 and 30a (FIG. 3) originates, which completely penetrates the valve holder 10 and discharges directly into the camshaft chamber (not shown) of the fuel injection pump. The second outlet bore 30a of FIG. 3—unlike the second outlet bore 30 of FIG. 1—is embodied as a throttle bore (for which see details in the description hereinafter).

The internal design of the valve insert 13a of FIG. 3 differs from the embodiment of FIG. 1 as follows.

A special feature of the pressure limiting valve of FIG. 3 is that the first outlet bore, identified overall here by 22a, is embodied at its transition to the valve chamber 21 as a throttle bore 31 and is sealed off at its rear end—at 32. Furthermore, the first outlet bore 22a communicates with the cylindrical chamber 12 that receives the valve spring 25 via a connecting bore 33. The second outlet bore 30a, as already noted, is furthermore embodied as a throttle bore. Thus when the pressure limiting valve is closed, an outflow of fuel from the valve chamber 21 via the first outlet bore 22a and the connecting bore 33 is possible solely into the cylindrical chamber 12 and from there through the second outlet bore 30a (throttle).

Finally, the embodiment of FIG. 3 also differs in the special feature that a third outlet bore 34 is provided, which originates—at a right angle or essentially at a right angle—at the cylindrical guide bore 14 of the valve piston 15. The third outlet bore 34 has a comparatively large diameter and cooperates with a control edge 35 on the valve piston 15, which edge is embodied at the transition from the conical part 17 to the cylindrical part 16 of the valve piston 15. To that end, the third outlet bore 34—oriented transversely to the longitudinal axis 29 of the pressure limiting valve—originates not at the valve chamber 21 but rather—above the conical valve piston portion 17—at the guide bore 14.

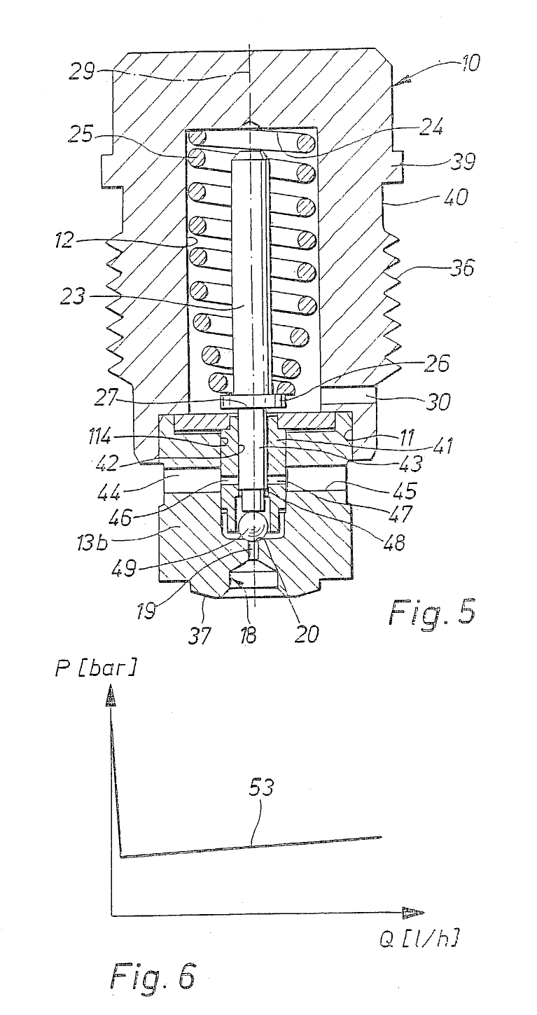

A quite essential special feature of the pressure limiting valve of the invention, which is common not only to the embodiments described above of FIGS. 1 and 3 but also to the embodiments, not yet described in their structure, of FIGS. 5 and 7 (for which see the descriptions hereinafter), is that the pressure limiting valve is not disposed outside the fuel injection pump but rather is screwed directly into the pump body (not shown) and integrated with it and sealed off on both the high-pressure side and low-pressure side from it. To that end, the valve holder 10 on its outer circumference has a screw thread 36, which cooperates with a corresponding female thread in the pump body. The sealing off of the pressure limiting valve from the pump body (not shown) is effected on the one hand (on the high-pressure side) by a biting edge 37 and on the other (on the low-pressure side) via an O-ring 38. To that end, above the screw thread 36 and axially spaced apart from it, a collar 39 is embodied on the valve holder 10, in such a way that between the screw thread 36 and the collar 39, an annular groove 40 is created, in which the O-ring 38 is disposed for sealing off the pressure limiting valve on the low-pressure side.

In the embodiment of FIG. 5, components that are the same as or similar to the embodiment of FIG. 1 or the variant of FIG. 3 are provided with the same reference numerals as in FIGS. 1 and 3, respectively.

A special feature of the embodiment of FIG. 5 is that it is not directly the valve piston but rather a cylindrical piston insert 41 that is disposed in a bore 114 of the valve insert 13b, this insert having a piston guide bore 42, which is concentric with the central bore 114 and in which the valve piston 43 is guided. Moreover, two aligned first outlet bores 44, 45 are provided, which penetrate the valve insert 13b and the piston insert 41 perpendicularly or essentially perpendicularly to their common center axis 29. Portions 46, 47 of the outlet bores 44, 45 that penetrate the piston insert 41 have a lesser diameter than the other portions of the outlet bore that penetrate the valve insert 13b.

A further special feature of the variant of FIG. 5 is that the valve piston 43 is embodied in stepped fashion, and at the stepped cross sectional transition, a control edge 48 is formed, which cooperates with the outlet bores 44, 46; 45, 47. The valve seat 20 cooperates with a spherical sealing element 49, which is acted upon by the valve piston 43.

The valve variant of FIG. 7 corresponds in its structure essentially to the embodiment of FIG. 1. With regard to certain functional distinctions, see the descriptions hereinafter.

The functional special features of the variants, described above in terms of their structure, of the pressure limiting valve of the invention will now be explained.

The so-called system pressure is applied to each inlet bore 18, 19.

If in the embodiment of FIG. 1 the force comprising the system pressure and the sealing area exceeds the prestressing force of the valve spring 25, then the valve piston 15 lifts from its valve seat 20 (conical, spherical, flat seat, etc.). To enable an unhindered motion of the valve piston 15, the second outlet bore 30 is required. Without the second outlet bore 30, a dynamic piston motion would in fact not be possible—because of the incompressible fuel. The second outlet bore 30 can be designed, by means of diameter variations, as a piston damper (system damper).

The outflowing fuel quantity is diverted via the first outlet bore 22 directly into the camshaft chamber of the high-pressure pump. This makes additional external return lines unnecessary.

The option now exists of designing the first outlet bore 22 from two different standpoints.

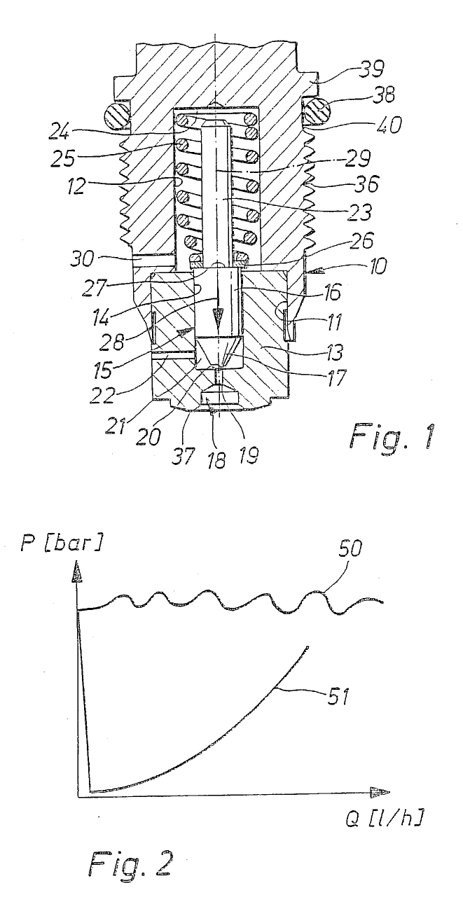

In one possible alternative, the first outlet bore 22 can be designed such that after the opening of the pressure limiting valve, a system pressure corresponding to the opening pressure builds up. The resultant characteristic curve can be seen in FIG. 2, where it is marked 50. To that end, the first outlet bore 22 should be dimensioned such that it does not act as a throttle. The result of this alternative design is a self-regulating—single-stage—pressure limiting valve (the valve piston 15 “floats”). Emergency operation of the vehicle at system pressure corresponding to the opening pressure of the valve is possible.

A possible second alternative design is characterized by the following provisions. The throttle bore 19 and first outlet bore 22 must be adapted such that the valve piston 15, after opening of the valve, moves with its boltlike stop 23 against the counterpart stop 24 in the valve holder 10. The system pressure collapses under the opening pressure of the injection nozzles (not shown), and the system shuts off. The resultant characteristic curve is marked 51 in FIG. 2.

In the embodiment of FIG. 3, a two-stage pressure limiting valve is used. It functions as follows.

If the system pressure rises above the valve opening pressure, then the outflowing fuel quantity flows through the throttle 31 of the first outlet bore 22a and through the connecting bore 33 into the cylindrical chamber 12 downstream of the valve piston 15, where it builds up a counterpressure, which exerts a force in the operative direction 28 of the spring and thus prevents a “hard impact” of the valve. This counterpart pressure can be reduced only via the second outlet bore 30a, designed as an adapted throttle bore. The valve piston 15 lifts from the valve seat 20, until the control edge 35 opens the third outlet bore 34.

Given an adapted design of the throttles 19, 31 and 30a, the pressure limiting valve of FIG. 3 regulates a system pressure, via a variable fuel throughput (Q), as indicated by the course of the characteristic curve 52 in FIG. 4.

A further embodiment of a two-stage pressure limiting valve is seen from FIG. 5. Here the system pressure prevails at the inlet throttle 19. If the system pressure exceeds the prestressing force of the spring 25, then the sealing element 49 lifts from the valve seat 20 and displaces the valve piston 43 upward, until its control edge 48 uncovers the first outlet bores 44, 45, or their portions 46, 47 of narrowed cross section. The fuel quantity then flows via the first outlet bores 44, 45 into the camshaft chamber (not shown) of the high-pressure pump.

Via the regulating motion between the outlet bores 44, 45 (or their portions 46, 47) and the control edge 48, a system pressure is established after the valve opening that makes emergency travel possible via the entire pumping flow (Q) of the high-pressure pump. To achieve this pressure regulation, the bores 19 and 44, 45 (46, 47) and the diameter of the valve piston 43 must be adapted exactly to one another. The result is a characteristic curve 53 shown in FIG. 6.

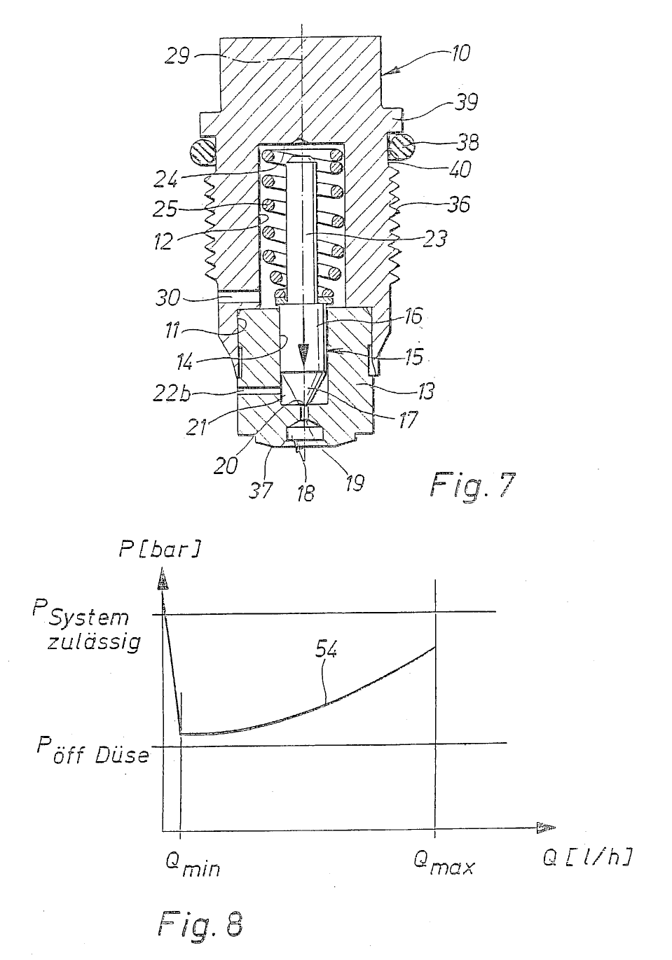

The structure and function of the variant of the pressure limiting valve of the invention, seen in FIG. 7, are essentially equivalent to the embodiment of FIG. 1. By suitable adaptation of the first outlet bore 22b, designed as a throttle, a characteristic pressure curve 54 of FIG. 8 can be attained. To that end, the first outlet bore 22b is designed such that after the opening of the valve, at minimal pumping capacity of the high-pressure pump (idling), a system pressure above the nozzle opening pressure results. The valve piston 15 at that time rests with its boltlike stop part 23 on the counterpart stop (bottom 24 of the cylindrical chamber 12) in the valve holder 10. The system pressure now—following Bernoulli's Law—rises as the pumping rate of the high-pressure pump increases. At maximum pumping capacity of the high-pressure pump, the allowable system pressure must not be exceeded. Emergency travel is thus possible, within certain pumping rates of the high-pressure pump.

1. A fuel injection pump for internal combustion engines, in particular Diesel engines, having a pressure limiting valve which has a valve holder (10), a high-pressure connection (inlet bore 18), a return connection (outlet bore 22, 22a, 22b, 44, 45), a valve seat (20) oriented toward the inlet bore, an axially displaceable valve piston (15, 43), and a valve spring (25) urging the valve piston in the direction of the valve seat, characterized in that the pressure limiting valve is integrated directly with the fuel injection pump and is sealed off on the high-pressure side and low-pressure side (at 37 and 38, 39, respectively) from the pump body.

2. The fuel injection pump of claim 1, characterized in that the pressure limiting valve is screwed (36) into the pump body and is sealed off from it on the high-pressure side via a biting edge (37) and on the low-pressure side via an O-ring 38.

3. The fuel injection pump of claim 2, characterized in that the valve holder (10) on its outer circumference has a screw thread (36), which cooperates with a corresponding female thread in the pump body.

4. The fuel injection pump of claim 2 or 3, characterized in that above the screw thread (36) and axially spaced apart from it, a collar (39) is embodied on the valve holder (10), in such a way that between the screw thread (36) and the collar (39), an annular groove (40) is created in which the O-ring (38) is disposed for sealing off the pressure limiting valve on the low-pressure side.

5. The fuel injection pump of one or more of the foregoing claims, characterized in that the inlet bore (18), valve seat (20) and valve piston (15) are disposed in a separate valve insert (13, 13a), which is inserted sealingly into a receptacle (11) in the valve holder (10), coaxially thereto, and that in the valve insert (13, 13a), a valve chamber (21) surrounding the valve piston (15) is embodied, from which a first outlet bore (22, 22a, 22b), penetrating the valve insert (13, 13a) radially or essentially radially, begins (FIGS. 1, 3 and 7).

6. The fuel injection pump of claim 5, characterized in that the valve insert (13, 13a, 13b) is embodied cylindrically and is press-fitted into a correspondingly cylindrical receptacle (11) in the valve holder (10).

7. The fuel injection pump of claim 5 or 6, characterized in that the valve piston (15) in the valve insert (13, 13a) is disposed and guided in a cylindrical guide bore (14), and that the valve piston (15) has a conical shape on its (forward) end (17) oriented toward the valve seat (20), in such a way that the region (21) toward the valve seat of the guide bore (14) that surrounds the conical end (17) of the valve piston (15) simultaneously forms the valve chamber (FIGS. 1, 3 and 7).

8. The fuel injection pump of claim 5, 6 or 7, characterized in that on the rear of the valve piston (15, 43) in the valve holder (10), a cylindrical chamber (12) extends, which receives the valve spring (25) acting on the valve piston (15, 43).

9. The fuel injection pump of claim 8, characterized in that the cylindrical chamber (12) is embodied as a blind bore, from which a second outlet bore (30, 30a), penetrating the valve holder (10) radially or essentially radially, begins (FIGS. 1, 3 and 7).

10. The fuel injection pump of claim 8 or 9, characterized in that a boltlike stop part (23), protruding into the cylindrical chamber (12) and surrounded by the valve spring (25), is formed onto the rear end (27) of the valve piston (15, 43) and cooperates on its end with the bottom (24), forming a counterpart stop, of the valve chamber (12).

11. The fuel injection pump of claim 10, characterized in that the valve spring (25) is braced on one end—directly or indirectly via a disk (26)—on a shoulder (27) embodied at the transition from the valve piston (15) to the boltlike stop part (23), and on the other end is braced on the bottom (24) of the cylindrical chamber (12).

12. The fuel injection pump of one or more of the foregoing claims, characterized in that the valve spring (25) has a reduced diameter toward the valve piston.

13. The fuel injection pump of one or more of claims 5-12, which is embodied as a high-pressure pump and has a camshaft disposed in a camshaft chamber, characterized in that the outlet bores (22, 22a, 22b, 30, 30a, 34, 44, 45) discharge directly into the camshaft chamber of the high-pressure pump.

14. The fuel injection pump of one or more of claims 5-13, characterized in that the first outlet bore (22) is designed in its diameter such that after the opening of the pressure limiting valve, a system pressure corresponding to the opening pressure results (FIGS. 1 and 2).

15. The fuel injection pump of one or more of claims 5-13, in which the inlet bore (18) of the pressure limiting valve is embodied, in its region forming the valve seat (20), as a throttle bore (19), characterized in that the throttle bore (19) and the first outlet bore (22) are adapted in their diameters to one another such that the valve piston (15), after the opening of the pressure limiting valve, comes to rest with its boltlike stop (23) on the counterpart stop (24) in the valve holder (10) (FIG. 1).

16. The fuel injection pump of one or more of claims 9-15, characterized in that the second outlet bore (22, 22b) is designed in its diameter such that it serves to damp the valve piston (15) (system damping) (FIGS. 1 and 7).

17. The fuel injection pump of one or more of claims 5-14, characterized in that the first outlet bore (22a), at its transition to the valve chamber (21), is embodied as a throttle bore, and that the first outlet bore (22a) communicates through a connecting bore (33) with the cylindrical chamber (12) that receives the valve spring (25) (FIG. 3).

18. The fuel injection pump of claim 17, characterized in that the first outlet bore (22a) is sealed off, on its end (at 32), remote from the valve chamber (21), in such a way that when the pressure limiting valve is closed, an 20 outflow from the valve chamber (21) via the first outlet bore (22a) and the connecting bore (33) is possible solely into the cylindrical chamber (12), and from there through the second outlet bore (30a).

19. The fuel injection pump of claim 17 or 18, characterized in that the second outlet bore (30a) is embodied as a throttle bore.

20. The fuel injection pump of claim 17, 18 or 19, characterized in that a third outlet bore (34) is provided, which originates—at a right angle or essentially at a right angle—at the cylindrical guide bore (14) of the valve piston (15) (FIG. 3).

21. The fuel injection pump of claim 20, characterized in that the third outlet bore (34) is disposed above the valve chamber (21) defined by the conical end region (17) of the valve piston (15).

22. The fuel injection pump of one or more of claims 1-6, characterized in that a cylindrical piston insert (41) is guided in a central bore (114) of the valve insert (13b) and has a piston guide bore (42), which is concentric with the central bore (114) and in which the valve piston (43) is guided (FIG. 5).

23. The fuel injection pump of claim 22, characterized by two first outlet bores (44, 45), aligned with one another, which penetrate the valve insert (13b) and the piston insert (41) perpendicularly, or essentially perpendicularly, to their common center axis (29).

24. The fuel injection pump of claim 23, characterized in that portions (46, 47) of the outlet bores (44, 45) that penetrate the piston insert (41) have a smaller diameter than the other outlet bore portions that penetrate the valve insert (13b).

25. The fuel injection pump of claim 22, 23 or 24, characterized in that the valve piston (43) is embodied stepped form and at the stepped diameter transition, a control edge (48) is formed, which cooperates with the outlet bores (44, 46; 45, 47).

26. The fuel injection pump of one or more of claims 22-24, characterized in that the valve seat (20) cooperates with a spherical sealing element (49) which is acted upon by the valve piston (43).
